(19) United States
(12) Patent Application Publication
(10) Pub. No.: US 2026/0014601 A1
(43) Pub. Date: Jan. 15, 2026

(54) PIPE CLEANING APPARATUS

(71) Applicant: SAMSUNG ELECTRONICS CO., LTD., Suwon-si (KR)

(72) Inventors: Inwook Koo, Suwon-si (KR); Sangwoo Um, Suwon-si (KR); Jihyeong Lee, Suwon-si (KR); Chanho Lee, Suwon-si (KR); Eui Jin Kim, Suwon-si (KR); Taijong Sung, Suwon-si (KR)

(73) Assignee: SAMSUNG ELECTRONICS CO., LTD., Suwon-si (KR)

(21) Appl. No.: 19/077,252

(22) Filed: Mar. 12, 2025

(30) Foreign Application Priority Data
Jul. 11, 2024 (KR) 10-2024-0091521

(51) Int. Cl. B08B 9/051; B08B 13/00

(52) U.S. Cl. CPC B08B 9/051; B08B 13/00; B08B 2205/00; B08B 2209/032

(57) ABSTRACT

A pipe cleaning apparatus includes: a driving module; a cleaning module; and a joint module connecting the driving module and the cleaning module, wherein the driving module includes: a hollow frame extending in a horizontal direction; a pneumatic cylinder connected to a first end of the hollow frame; a first slider installed on the hollow frame; a second slider on the hollow frame and spaced apart from the first slider, wherein the second slider is connected to the pneumatic cylinder; front wheel assemblies on the hollow frame; and rear wheel assemblies on the hollow frame. In a cross-sectional view of the hollow frame, the rear wheel assemblies and the front wheel assemblies are arranged alternately with each other in a circumferential direction, and the front wheel assemblies are connected to the first slider, and the rear wheel assemblies are connected to the second slider.

### CROSS-REFERENCE TO RELATED APPLICATION

This application claims priority from Korean Patent Application No. 10-2024-0091521, filed on Jul. 11, 2024, in the Korean Intellectual Property Office, and all the benefits accruing therefrom under 35 U.S.C. 119, the contents of which in its entirety are herein incorporated by reference.

### BACKGROUND

### 1. Field

Embodiments of the present disclosure relate to a pipe cleaning apparatus.

### 2. Description of Related Art

In a semiconductor process, solid by-products accumulate on an inner surface of a pipe due to fluids and floating substances passing through the pipe. For example, components such as SiO₂ and NH₄Cl accumulate in a solid form on the inner wall of the pipe. When the by-products accumulate inside the pipe, this may reduce the fluid transport efficiency of the pipe, and may cause pipe clogging and add a load to the semiconductor equipment, leading to the failure of the semiconductor equipment. Currently, workers in semiconductor FABs perform maintenance work to remove the by-products inside the pipe manually. Recently, a pipe cleaning apparatus that removes the by-products accumulated in a pipe used in the semiconductor process is being studied.

### SUMMARY

According to embodiments of the present disclosure, a pipe cleaning apparatus that may clean by-products accumulated inside a pipe in an unmanned manner may be provided.

According to embodiments of the present disclosure, a pipe cleaning apparatus may be provided and include: a driving module; a cleaning module including a camera and a front brush; and a joint module connecting the driving module and the cleaning module, the joint module including at least one joint, wherein the driving module includes: a hollow frame extending in a horizontal direction; a pneumatic cylinder connected to a first end of the hollow frame; a first slider installed on the hollow frame; a second slider on the hollow frame and spaced apart from the first slider, wherein the second slider is connected to the pneumatic cylinder; a plurality of front wheel assemblies on the hollow frame; and a plurality of rear wheel assemblies on the hollow frame, wherein, in a cross-sectional view of the hollow frame, the plurality of rear wheel assemblies and the plurality of front wheel assemblies are arranged alternately with each other in a circumferential direction, and wherein the plurality of front wheel assemblies are connected to the first slider, and the plurality of rear wheel assemblies are connected to the second slider.

According to embodiments of the present disclosure, a pipe cleaning apparatus may be provided and include: a cleaning module; a driving module; and a joint module connecting the cleaning module and the driving module, wherein the cleaning module includes: a rotator; a front brush on a side surface of the rotator; a camera on a front surface of the rotator; a rear brush spaced apart from the front brush in a horizontal direction; and a suction part between the front brush and the rear brush, wherein the joint module includes a first universal joint, wherein the driving module includes: a hollow frame extending in the horizontal direction; a pneumatic cylinder that is hollow and connected to a first end of the hollow frame; a first slider on the hollow frame; a second slider on the hollow frame and spaced apart from the first slider, wherein the second slider is connected to the pneumatic cylinder; a plurality of front wheel assemblies on the hollow frame, wherein each of the plurality of front wheel assemblies includes a first connection structure and a second connection structure that is longer than the first connection structure; and a plurality of rear wheel assemblies on the hollow frame, wherein each of the plurality of rear wheel assemblies includes a third connection structure and a fourth connection structure, wherein, in a cross-sectional view of the hollow frame, the plurality of rear wheel assemblies and the plurality of front wheel assemblies are arranged alternately with each other in a circumferential direction, wherein the first connection structure is connected to a second end of the hollow frame, and the second connection structure is connected to the first slider, and wherein the third connection structure is connected to the second slider, and the fourth connection structure is connected to the first slider.

According to embodiments of the present disclosure, a pipe cleaning apparatus may be provided and include: a cleaning module; a driving module; and a joint module connecting the cleaning module and the driving module, wherein the cleaning module includes: a rotator; a front brush on a side surface of the rotator; a rear brush horizontally spaced from the front brush; a suction part between the front brush and the rear brush; a camera on a protrusion horizontally spaced from the rotator; and a front caster on a side surface of the protrusion, wherein the joint module includes: a first universal joint connected to the driving module; a second universal joint connected to the cleaning module; and a third universal joint connecting the first universal joint and the second universal joint, wherein the driving module includes: a hollow frame extending in a horizontal direction; a pneumatic cylinder that is hollow and on a first end of the hollow frame; a first slider on the hollow frame; a second slider on the hollow frame and spaced apart from the first slider, wherein the second slider is connected to the pneumatic cylinder; a plurality of front wheel assemblies on the hollow frame, wherein each of the plurality of front wheel assemblies includes a first connection structure and a second connection structure; a plurality of rear wheel assemblies on the hollow frame, wherein each of the plurality of rear wheel assemblies includes a third connection structure and a fourth connection structure, wherein, in a cross-sectional view of the hollow frame, the plurality of rear wheel assemblies and the plurality of front wheel assemblies are arranged alternately with each other in a circumferential direction; and a first caster on each of the second connection structure and the fourth connection structure, wherein the first connection structure is connected to a second end of the hollow frame, and the second connection structure is connected to the first slider, and wherein the third connection structure is connected to the second slider, and the fourth connection structure is connected to the first slider.

Aspects and advantages of embodiments of the present disclosure are not limited to the above-mentioned aspects and advantages. Other aspects and advantages of embodiments of the present disclosure that are not mentioned above may be understood from following descriptions and more clearly understood from embodiments of the present disclosure. Further, it will be readily appreciated that the aspects and advantages of the present disclosure may be realized by features and combinations thereof as described in the present disclosure.

The specific details of other embodiments are included in the detailed description and drawings.

### BRIEF DESCRIPTION OF DRAWINGS

The above and other aspects and features of embodiments of the present disclosure will become more apparent by describing in detail example embodiments thereof with reference to the attached drawings, in which:

FIG. 1 is a diagram showing that a pipe cleaning apparatus according to some embodiments of the present disclosure cleans a pipe installed in a semiconductor FAB.

FIG. 2 and FIG. 3 are diagrams illustrating a pipe cleaning apparatus according to some embodiments of the present disclosure.

FIG. 4 is a diagram illustrating a cleaning module, a joint module, and a driving module of the pipe cleaning apparatus illustrated in FIG. 2.

FIGS. 5 to 10 are diagrams illustrating the driving module of FIG. 4.

FIGS. 11 to 13 are diagrams illustrating the cleaning module of FIG. 4.

FIGS. 14 to 17 are diagrams illustrating the joint module of FIG. 4.

### DETAILED DESCRIPTION

Although terms such as “first,” “second,” “upper,” and “lower” are used herein to describe various elements or components, these element or components are not limited by the terms. Rather, the terms are merely used herein to distinguish one element or component from another element or component. Therefore, a “first” element or component as mentioned below may also be a “second” element or component, and vice versa, within the technical spirit of the present disclosure. Further, a “lower” element or component as mentioned below may also be an “upper” element or component, and vice versa, within the technical spirit of the present disclosure.

It will be understood that when an element or layer is referred to as being “on,” “connected to,” or “coupled to” another element or layer, it can be directly on, connected to, or coupled to the other element or layer or intervening elements or layers may be present. In contrast, when an element or layer is referred to as being “directly on,” “directly connected to,” or “directly coupled to” another element or layer, there are no intervening elements or layers present.

Hereinafter, non-limiting example embodiments of the present disclosure are described in detail with reference to the attached drawings. The same reference numerals are used for the same components in the drawings, and duplicate descriptions thereof may be omitted.

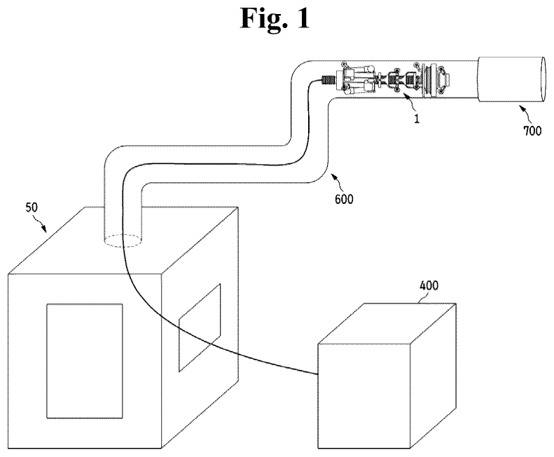

FIG. 1 is a diagram showing that a pipe cleaning apparatus according to some embodiments of the present disclosure cleans a pipe installed in a semiconductor FAB.

Referring to FIG. 1, the semiconductor FAB may include a cabinet 50, a pipe 600, a duct 700, and a pipe cleaning apparatus 1.

The cabinet 50 may include a process chamber and a scrubber. For example, a semiconductor process may be performed in the process chamber. After the semiconductor process is performed, gas depressurized from the process chamber may be treated in the scrubber. The gas treated in the scrubber may be depressurized to the outside through the duct 700 via the pipe 600.

The pipe 600 may connect the cabinet 50 and the duct 700 to each other. The pipe 600 may be a passageway in which multiple pipes are connected to each other. During the process in which the gas used in the process chamber is treated, by-products may accumulate inside the pipe 600. The by-products may be in various forms, such as sludge including moisture, solids, etc.

A diameter of the pipe 600 including the pipe cleaning apparatus 1 according to some embodiments of the present disclosure may be in a range of 80 mm inclusive to 180 mm inclusive. The size of the pipe used in the semiconductor process may be smaller than a size of a pipe used in heavy industry. A target performance cannot be satisfied simply by changing a configuration in order to miniaturize the pipe cleaning apparatus. However, the pipe cleaning apparatus 1 according to some embodiments of the present disclosure may be applied to a small-sized semiconductor pipe having a diameter in a range of 80 mm inclusive to 180 mm inclusive.

In a comparative embodiment, a worker directly removes the pipe 600 and the cabinet 50 and the pipe 600 and the duct 700 from each other. The worker transports the pipe 600 that is removed and directly clean the inside of the pipe 600. The worker cleans the inside of the pipe 600 and then reconnects the pipe 600 and the cabinet 50 and the pipe 600 and the duct 700 to each other.

However, the pipe cleaning apparatus 1 according to some embodiments of the present disclosure may clean the inside of the pipe 600 without the worker removing and transporting the pipe 600.

The pipe cleaning apparatus 1 may be inserted into the inside of the pipe 600. For example, in some embodiments, the pipe 600 and the cabinet 50 may be removed from each other. The pipe cleaning apparatus 1 may be introduced into the pipe through a lowermost end of the pipe 600 that is removed from the cabinet 50. Alternatively, in some embodiments, the cabinet 50 may be equipped with a door through which the pipe cleaning apparatus 1 may be introduced. The pipe cleaning apparatus 1 may be introduced into the pipe 600 through the door. The pipe cleaning apparatus 1 may remove the by-product existing inside the pipe 600. The pipe cleaning apparatus 1 may suction the by-product and discharge the suctioned by-product to a suction module 400. The by-product may be stored in the suction module 400.

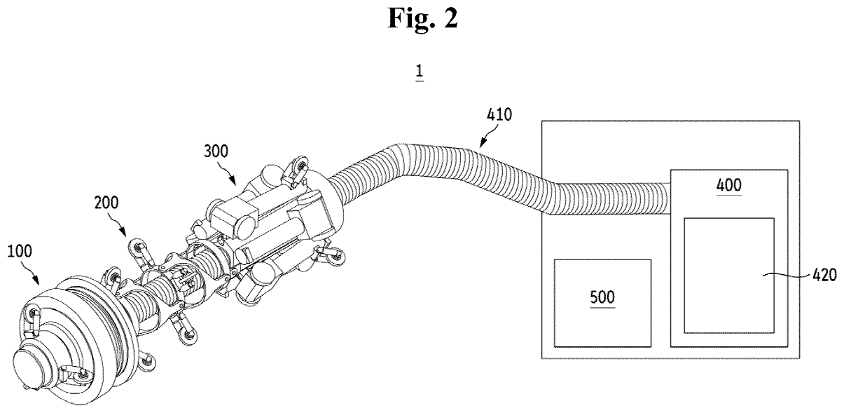

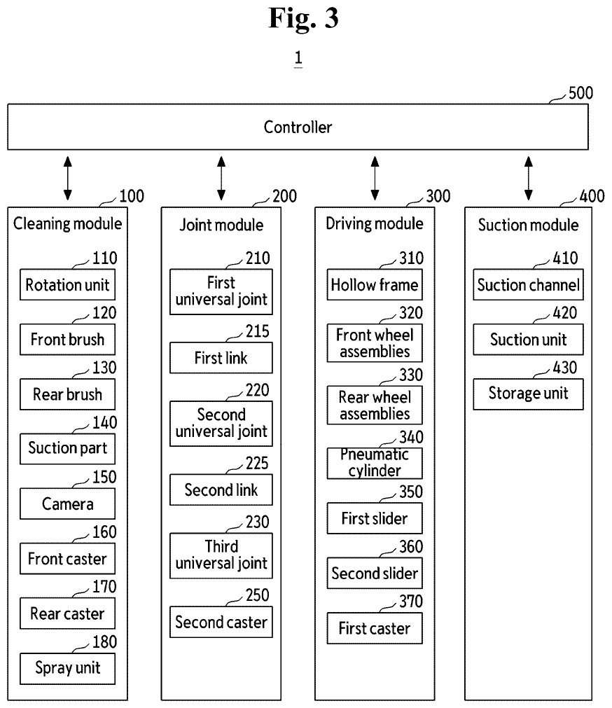

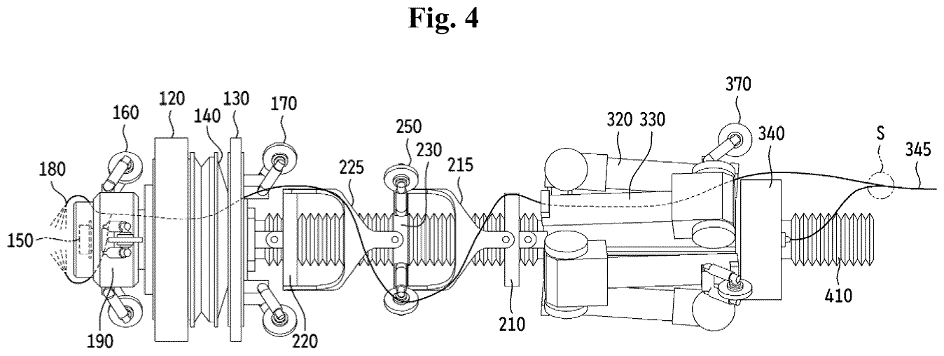

FIG. 2 and FIG. 3 are diagrams illustrating a pipe cleaning apparatus according to some embodiments of the present disclosure. FIG. 4 is a diagram illustrating a cleaning module, a joint module, and a driving module of the pipe cleaning apparatus illustrated in FIG. 2.

Referring to FIG. 2 to FIG. 4, a pipe cleaning apparatus 1 according to some embodiments of the present disclosure may include a cleaning module 100, a joint module 200, a driving module 300, a suction module 400, and a controller 500.

The cleaning module 100 may include a rotation unit 110 (e.g., a rotator), a front brush 120, a rear brush 130, a suction part 140, a camera 150, a front caster 160, a rear caster 170, and a spray unit 180 (e.g., an air sprayer). Each of the components will be described in detail later.

The cleaning module 100 may identify presence or absence of the by-product and an amount of the by-product inside the pipe 600 using the camera 150. The by-product may enter the suction part 140 under the operation of the rotation unit 110 and the front brush 120 of the cleaning module 100. For example, the rotation unit 110 may rotate to rotate the front brush 120. When the front brush 120 rotates, the by-product may be scattered. The by-product may be suctioned with the suction part 140 along a flow path. The by-product suctioned with the suction part 140 may move to the suction module 400 and stored therein.

The driving module 300 may include a hollow frame 310, a plurality of front wheel assemblies 320, a plurality of rear wheel assemblies 330, a pneumatic cylinder 340, a first slider 350, a second slider 360, and a plurality of first casters 370. A description of each of the components will be set forth in detail later.

The driving module 300 may be in contact with the pipe 600. A size of the driving module 300 may be adjusted to fit a size of the pipe 600. For example, radial dimensions of the plurality of front wheel assemblies 320 and a plurality of rear wheel assemblies 330 may be adjusted using the pneumatic cylinder 340. The size of the driving module 300 may be adjusted to fit the size of the pipe 600 by adjusting the radial dimensions of the plurality of front wheel assemblies 320 and the plurality of rear wheel assemblies 330.

The driving module 300 may move along the inner wall of the pipe 600. The plurality of front wheel assemblies 320 and the plurality of rear wheel assemblies 330 may move back and forth along the inner wall of the pipe 600. The driving module 300 may move forward or backward, such that the cleaning module 100 may move to a position where the by-product exists.

The joint module 200 may include a first universal joint 210, a second universal joint 220, a third universal joint 230, a first link 215, a second link 225, and a second caster 250. A description of each of the components will be set forth in detail later.

The joint module 200 may connect the driving module 300 and the cleaning module 100 to each other.

The suction module 400 may include a suction channel 410, a suction unit 420 (e.g., a suction generator), and a storage unit 430 (e.g., a storage).

The suction channel 410 may be connected to the suction unit 420. The suction channel 410 may extend through the driving module 300 and the joint module 200. The suction channel 410 may extend through the driving module 300 and the joint module 200 to the suction part 140 of the cleaning module 100. The suction channel 410 may be a passage through which the by-product suctioned with the suction part 140 of the cleaning module 100 moves. The by-product having passed through the suction channel 410 may be sucked into the suction unit 420.

The suction unit 420 may generate an airflow in the suction channel 410. When the airflow is generated in the suction channel 410, the by-product suctioned with the suction part 140 of the cleaning module 100 may move to the suction unit 420 through the suction channel 410. The by-product moved to the suction unit 420 may be stored in the storage unit 430. According to embodiments, the suction unit 420 (e.g., the suction generator) may include, for example, a pump.

The controller 500 may control the cleaning module 100, the driving module 300, and the suction module 400 wirelessly or in a wired manner. The controller 500 may control the driving module 300 to control the pipe cleaning apparatus 1 to move inside the pipe 600. The controller 500 may control the cleaning module 100 to clean the by-product. The controller 500 may control the suction module 400 to generate the airflow so that the suction part 140 of the cleaning module 100 may suction the by-product.

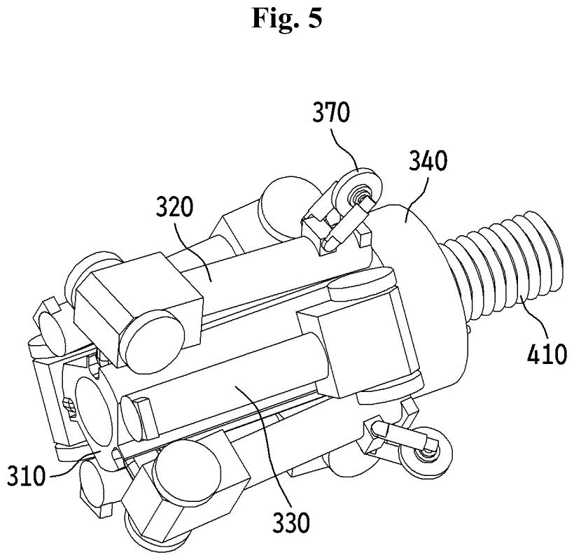

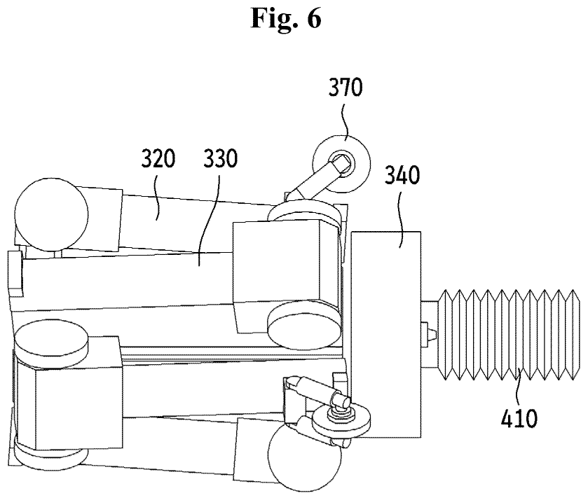

FIGS. 5 to 10 are diagrams illustrating the driving module of FIG. 4. The following describes in detail the components included in the driving module 300. As described above, the driving module 300 may include the hollow frame 310, the plurality of front wheel assemblies 320, the plurality of rear wheel assemblies 330, the pneumatic cylinder 340, the first slider 350, the second slider 360, and the plurality of first casters 370.

The hollow frame 310 may extend in a horizontal direction. Since the hollow frame 310 is hollow, the suction channel 410 may extend from the suction unit 420 and extend through the hollow frame 310.

In the cross-sectional view, a shape of the hollow frame 310 may be a polygonal shape with an empty interior. However, embodiments of the present disclosure are not limited thereto. The shape of the hollow frame 310 may be a circular or oval shape with an empty interior. The hollow frame 310 may be manufactured to have a size adapted to a size of the pipe used in the semiconductor process. Other components may be installed on the hollow frame 310. The hollow frame 310 may serve to support the other components.

The hollow frame 310 may include two opposite ends in a length direction thereof. One end of the hollow frame 310 may have an inlet defined therein through which the suction channel 410 enters the empty space of the hollow frame 310 from the suction unit 420. The other end of the hollow frame 310 may have an outlet defined therein through which the suction channel 410 exits the empty space of the hollow frame 310. The other end of the hollow frame 310 may be connected to the joint module 200. The other end of the hollow frame 310 may face the cleaning module 100.

The pneumatic cylinder 340 may be installed at one end of the hollow frame 310. The pneumatic cylinder 340 may surround one end of the hollow frame 310. The pneumatic cylinder 340 may be a hollow cylinder. Since the pneumatic cylinder 340 has an empty space therein, the pneumatic cylinder 340 may surround the hollow frame 310.

The pneumatic cylinder 340 may be adjusted in length in the horizontal direction while being disposed on the hollow frame 310. The pneumatic cylinder 340 may extend or retract to change its length in the horizontal direction while being disposed on the hollow frame 310. For example, the pneumatic cylinder 340 may include a body, a piston, and a rod. The body of the pneumatic cylinder 340 may be fixed to the hollow frame 310. The piston and the rod of the pneumatic cylinder 340 may move in a linear manner to adjust the length of the pneumatic cylinder 340.

The length of the pneumatic cylinder 340 may be adjusted such that the size of the driving module 300 may be adjusted to be adapted to the size of the pipe (e.g., the pipe 600). In this regard, the size of the driving module 300 may be a diameter of the driving module 300. For example, when the pneumatic cylinder 340 extends, the size of the driving module 300 may increase. When the pneumatic cylinder 340 retracts, the size of the driving module 300 may decrease.

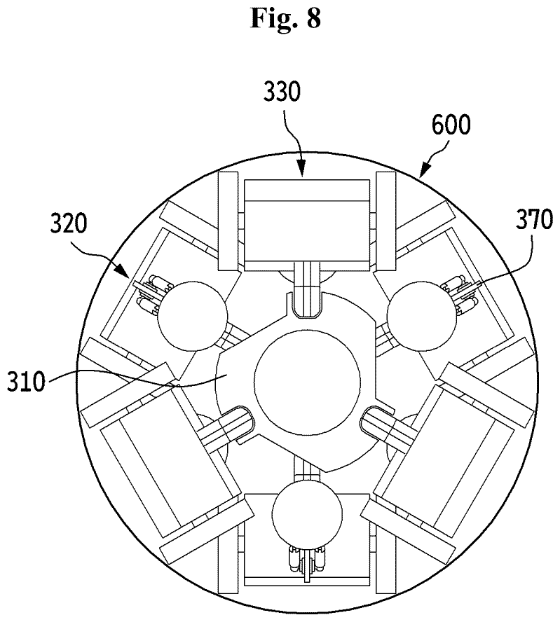

The plurality of front wheel assemblies 320 and the plurality of rear wheel assemblies 330 may be installed on the hollow frame 310. The plurality of front wheel assemblies 320 may be installed on the hollow frame 310 and arranged so as to be spaced from each other by an angular predetermined spacing. The plurality of rear wheel assemblies 330 may be installed on the hollow frame 310 and arranged so as to be spaced from each other by an angular predetermined spacing. The plurality of front wheel assemblies 320 and the plurality of rear wheel assemblies 330 may be arranged alternately with each other in a circumferential direction in the cross sectional view. For example, as illustrated in FIG. 8, three front wheel assemblies 320 and three rear wheel assemblies 330 may be arranged alternately with each other in a circumferential direction in the cross sectional view. However, embodiments of the present disclosure are not limited thereto. The number of front wheel assemblies 320 and the number of rear wheel assemblies 330 are not limited to those illustrated.

Each of the plurality of front wheel assemblies 320 may include a first short connection structure 321 (e.g., a first connection structure), a first long connection structure 322 (e.g., a second connection structure), and a first wheel 323. The first short connection structure 321 and the first long connection structure 322 may be connected to each other. Each of the first short connection structure 321 and the first long connection structure 322 may be embodied as one frame, and as a combination of a plurality of frames. The first wheel 323 may be installed on the first long connection structure 322. Two first wheels 323 may be installed on a side of the first long connection structure 322.

The plurality of rear wheel assemblies 330 may include a second short connection structure 331 (e.g., a third connection structure), a second long connection structure 332 (e.g., a fourth connection structure), and a second wheel 333. The second short connection structure 331 and the second long connection structure 332 may be connected to each other. each of the second short connection structure 331 and the second long connection structure 332 may embodied as one frame, and as a combination of a plurality of frames. The second wheel 333 may be installed on the second long connection structure 332. Two second wheels 333 may be installed on a side of the second long connection structure 332.

The second short connection structure 331 may be installed closer than the first short connection structure 321 to the pneumatic cylinder 340. The first short connection structure 321 may be installed farther than the second short connection structure 331 from the pneumatic cylinder 340. Accordingly, the second wheel 333 may be installed closer than the first wheel 323 to the pneumatic cylinder 340. The first wheel 323 may be installed farther than the second wheel 333 from the pneumatic cylinder 340. That is, the first wheels 323 and the second wheels 333 may be arranged in a zigzag pattern around the hollow frame 310 in the cross-sectional view. Since the first wheels 323 and the second wheels 333 are arranged in the zigzag pattern, a close contact force between the driving module 300 and the pipe 600 may be increased.

Each of the plurality of front wheel assemblies 320 and the plurality of rear wheel assemblies 330 may include a motor. The motor may be controlled by the controller 500. When the plurality of front wheel assemblies 320 and the plurality of rear wheel assemblies 330 come into contact with the inner wall of the pipe and the motors are turned on by the controller 500, the driving module 300 may move inside the pipe. Since the driving module 300 includes the plurality of front wheel assemblies 320 and the plurality of rear wheel assemblies 330, the driving module 300 may move forward or backward.

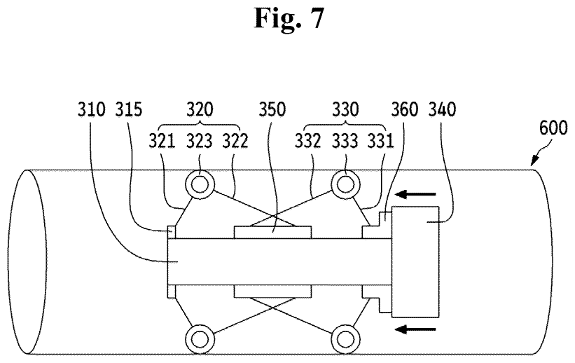

Referring to FIG. 7 to FIG. 10, the first slider 350 and the second slider 360 may be installed on the hollow frame 310. The plurality of front wheel assemblies 320 and the plurality of rear wheel assemblies 330 may be installed on the first slider 350 and the second slider 360. For example, the first slider 350 may be connected to the first long connection structure 322 of the front wheel assembly 320 and the second long connection structure 332 of the rear wheel assembly 330. The second slider 360 may be connected to the second short connection structure 331 of the rear wheel assembly 330.

The first slider 350 and the second slider 360 may move horizontally on and along the hollow frame 310. The first slider 350 and the second slider 360 may move independently on and along the hollow frame 310.

The first slider 350 may be spaced apart from the pneumatic cylinder 340. That is, the first slider 350 may be spaced from the pneumatic cylinder 340 by a predefined spacing. The first slider 350 may be installed between one end and the other end of the hollow frame 310. When the pneumatic cylinder 340 extends, the first slider 350 may move toward the other end of the hollow frame 310. When the pneumatic cylinder 340 retracts, the first slider 350 may move away from the other end of the hollow frame 310.

The second slider 360 may be connected to the pneumatic cylinder 340. Since the second slider 360 is connected to the pneumatic cylinder 340, the second slider may move integrally with the pneumatic cylinder 340. For example, when the pneumatic cylinder 340 extends, the second slider 360 may move toward the other end of the hollow frame 310. When the pneumatic cylinder 340 retracts, the second slider 360 may move away from the other end of the hollow frame 310.

The first long connection structure 322 of each of the plurality of front wheel assemblies 320 and the second long connection structure 332 of each of the plurality of rear wheel assemblies 330 may be connected to the first slider 350. The first short connection structure 321 of each of the plurality of front wheel assemblies 320 may be connected to the other end of the hollow frame 310. Specifically, the first short connection structure 321 of each of the plurality of front wheel assemblies 320 may be connected to a protrusion 315 protruding from the other end of the hollow frame 310. The protrusion 315 may be fixed to the other end of the hollow frame 310. The second short connection structure 331 of each of the plurality of rear wheel assemblies 330 may be connected to the second slider 360.

FIG. 7 and FIG. 8 are diagrams showing a case where the pneumatic cylinder 340 extends. When the pneumatic cylinder 340 extends, the first slider 350 and the second slider 360 may move toward the other end of the hollow frame 310. The first short connection structure 321 and the first long connection structure 322 of each of the plurality of front wheel assemblies 320 may move away from the hollow frame 310. Since the first long connection structure 322 moves away from the hollow frame 310, the first wheel 323 may come into contact with the pipe 600. The second short connection structure 331 and the second long connection structure 332 of each of the plurality of rear wheel assemblies 330 may move away from the hollow frame 310. Since the second long connection structure 332 moves away from the hollow frame 310, the second wheel 333 may come into contact with the pipe 600.

The pipe cleaning apparatus 1 according to some embodiments of the present disclosure may include the first slider 350 and the second slider 360 disposed on the hollow frame 310. The first slider 350 may be connected to the front wheel assembly 320 and the rear wheel assembly 330. The second slider 360 may be connected to the rear wheel assembly 330. Since the pipe cleaning apparatus 1 includes the first slider 350 and the second slider 360, a distance between the front wheel assembly 320 and the hollow frame 310 and a distance between the rear wheel assembly 330 and the hollow frame 310 may be independently adjusted. Furthermore, when the pneumatic cylinder 340 extends, a force may be individually transmitted to each of the first slider 350 and the second slider 360. Therefore, a force may be individually transmitted to the front wheel assembly 320 and the rear wheel assembly 330. Since the force from the pneumatic cylinder 340 is transmitted to each of the plurality of front wheel assemblies 320 and the plurality of rear wheel assemblies 330, a thrust of the pipe cleaning apparatus 1 may be maximized. Since the force from the pneumatic cylinder 340 is transmitted to each of the plurality of front wheel assemblies 320 and the plurality of rear wheel assemblies 330, a pipe support force may be maximized. In this regard, the pipe support force may be a force with which the plurality of front wheel assemblies 320 and the plurality of rear wheel assemblies 330 push the pipe 600.

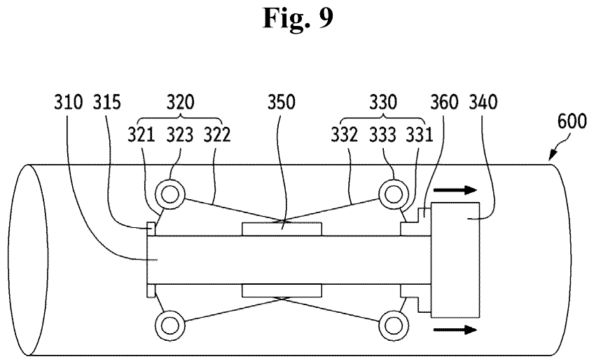

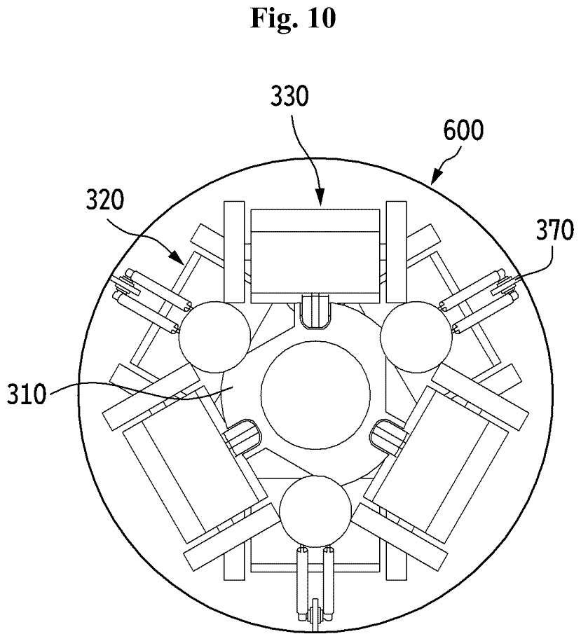

FIG. 9 and FIG. 10 are diagrams showing a case where the pneumatic cylinder 340 retracts. When the pneumatic cylinder 340 retracts, the first slider 350 and the second slider 360 may move away from the other end of the hollow frame 310. The first short connection structure 321 and the first long connection structure 322 of each of the plurality of front wheel assemblies 320 may be brought closer to the hollow frame 310. Since the first long connection structure 322 is brought closer to the hollow frame 310, the first wheel 323 may be removed from the pipe 600 (e.g., separated from an inner surface of the pipe 600). The second short connection structure 331 and the second long connection structure 332 of each of the plurality of rear wheel assemblies 330 may be brought closer to the hollow frame 310. Since the second long connection structure 332 moves further away from the hollow frame 310, the second wheel 333 may be removed from the pipe 600 (e.g., separated from the inner surface of the pipe 600).

Again, referring to FIG. 5 to FIG. 10, the driving module 300 may further include the first caster 370. The first caster 370 may be installed on the plurality of front wheel assemblies 320. The first caster 370 may be installed on the first long connection structure 322. The first caster 370 may be positioned closer than the first wheel 323 to the first slider 350. According to embodiments, the first caster 370 may be installed on the plurality of rear wheel assemblies 330.

A spacing between the first caster 370 and the hollow frame 310 and a spacing between the first wheel 323 and the hollow frame 310 may be different from each other. Each of the spacing between the first caster 370 and the hollow frame 310 and the spacing between the first wheel 323 and the hollow frame 310 may vary depending on whether the pneumatic cylinder 340 extends or retracts.

For example, as in FIG. 7 and FIG. 8, when the pneumatic cylinder 340 extends, the spacing between the first caster 370 and the hollow frame 310 may be smaller than the spacing between the first wheel 323 and the hollow frame 310. The first wheel 323 may be in contact with the pipe 600, while the first caster 370 may not be in contact with the pipe 600.

In another example, as in FIG. 9 and FIG. 10, when the pneumatic cylinder 340 retracts, the spacing between the first caster 370 and the hollow frame 310 may be larger than the spacing between the first wheel 323 and the hollow frame 310. The first caster 370 may be in contact with the pipe 600, while the first wheel 323 may not be in contact with the pipe 600.

After the pipe cleaning operation is completed, the pipe cleaning apparatus 1 may be withdrawn from the pipe 600. After the pipe cleaning operation is completed, the pneumatic cylinder 340 retracts, so that the front wheel assembly 320 and the pipe 600 (e.g., the inner surface thereof) may be removed (e.g., separated) from each other and the rear wheel assembly 330 and the pipe 600 (e.g., the inner surface thereof) may be removed (e.g., separated) from each other. The front wheel assembly 320 and the rear wheel assembly 330 may move away from the pipe 600. That is, the pipe support force between the driving module 300 and the pipe 600 may be removed, so that the pipe cleaning apparatus 1 may be removed from the pipe 600. When the first caster 370 is not installed, there may be no structure to support the pipe cleaning apparatus 1, so that the pipe cleaning apparatus 1 may fall onto the pipe 600 or collide with the pipe 600. The pipe 600 includes a straight line portion and a curved portion. Thus, when there is no structure supporting the pipe cleaning apparatus 1, it may be difficult to pull the pipe cleaning apparatus 1 out of the pipe 600. However, the pipe cleaning apparatus 1 according to some embodiments of the present disclosure may include the first caster 370. When the pneumatic cylinder 340 retracts, as shown in FIG. 10, the front wheel assembly 320 and the rear wheel assembly 330 may be removed (e.g., separated) from the pipe 600 (e.g., the inner surface thereof), and the first caster 370 may come into contact with the pipe 600. Since the first caster 370 may move along the shape of the pipe 600, the pipe cleaning apparatus 1 may be easily pulled out of the pipe 600.

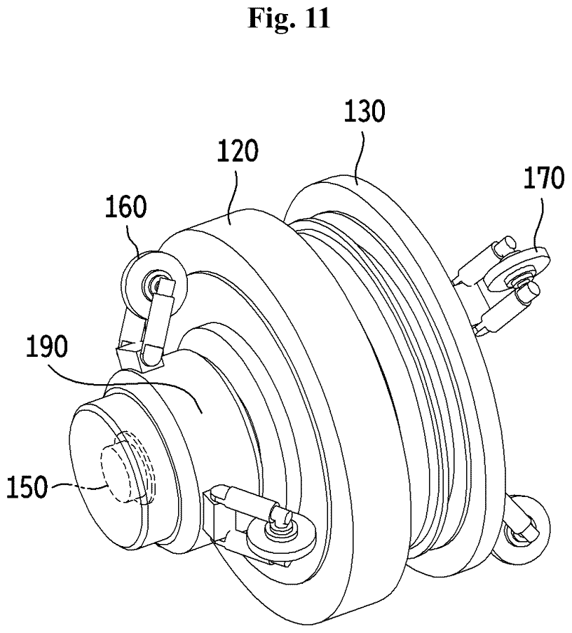

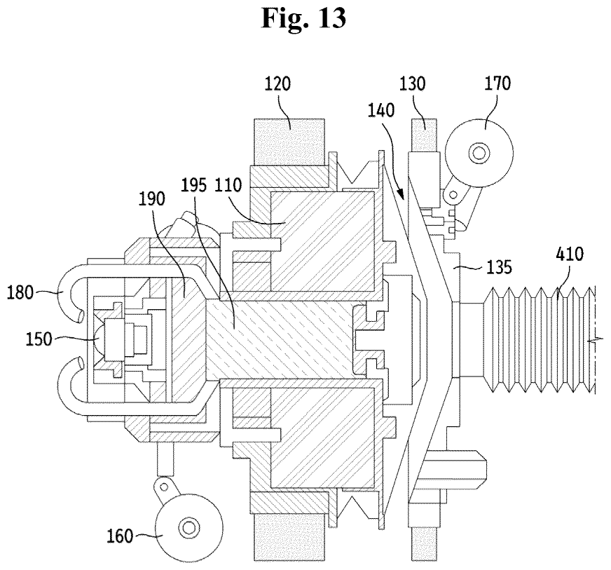

FIGS. 11 to 13 are diagrams illustrating the cleaning module of FIG. 4. As described above, the cleaning module 100 may include the rotation unit 110, the front brush 120, the rear brush 130, the suction part 140, the camera 150, the front caster 160, the rear caster 170, and the spray unit 180.

The rotation unit 110 may be installed on a frame 195 extending in a horizontal direction. The rotation unit 110 (e.g., the rotator) may be a hollow motor. Since the rotation unit 110 includes a hollow space therein, the frame 195 may extend through the rotation unit 110. The rotation unit 110 may be controlled in a wired manner or wirelessly. The rotation unit 110 may rotate under control of the controller 500. While the rotation unit 110 rotates, the frame 195 may not rotate.

The front brush 120 may be installed on the rotation unit 110. The front brush 120 may be rotated together with the rotation unit 110. The front brush 120 may scatter the by-product accumulated in the pipe 600 while rotating around a horizontal rotation axis. When the front brush 120 rotates and the suction unit 420 operates to generate the airflow, the scattered by-product may move to the suction channel 410 through the suction part 140.

The front brush 120 may have a spiral shape. However, embodiments of the present disclosure are not limited thereto. When the front brush 120 has the spiral shape, it may be easy for the brush to remove the by-product peeled off from the inner wall of the pipe 600.

The rear brush 130 may be horizontally spaced apart from the front brush 120. A plate 135 may be horizontally spaced apart from the frame 195. The plate 135 may be a hollow plate including an empty space therein. The rear brush 130 may be installed on a side surface of the plate 135. The rear brush 130 may be fixed to the side surface of the plate 135.

The suction part 140 may be installed between the front brush 120 and the rear brush 130. The suction part 140 may extend through the plate 135. The suction part 140 may be funnel-shaped. The suction part 140 may include an inlet through which the by-product existing in the pipe 600 enters the pipe cleaning apparatus 1.

The suction part 140 may be connected to the suction channel 410. The suction channel 410 may extend from the suction unit 420 through the hollow frame 310 of the driving module 300 and the joint module 200 so as to be connected to the suction part 140. The by-product suctioned with the suction part 140 may move through the suction channel 410. The by-product having moved through the suction channel 410 may be stored in the storage unit 430 of the suction module 400.

The rear brush 130 may prevent the by-product scattered based on the rotation of the front brush 120 from moving backwards. For example, the by-product scattered based on the rotation of the front brush 120 may collide with the rear brush 130. Since the suction part 140 is installed between the front brush 120 and the rear brush 130, the by-product having collided with the rear brush 130 may be collected in the suction part 140 without moving backwards. Since the pipe cleaning apparatus 1 includes the front brush 120, the rear brush 130, and the suction part 140 installed between the front brush 120 and the rear brush 130, the by-product suction efficiency may be increased.

The camera 150 may be installed on a front surface of the frame 195. The camera 150 may be installed on the protrusion 190 installed on the front surface of the frame 195. In some embodiments, the camera 150 may be installed on the front surface of the frame 195 without the protrusion 190.

The presence or absence of the by-product inside the pipe 600 may be identified in real time by the camera 150. Whether the by-product has been removed may be identified in real time through the camera 150. A location of the by-product may be identified through the camera 150, and then, the driving module 300 may move to the location of the by-product. It may be identified through the camera 150 that the by-product has not been entirely suctioned with the suction part 140 at the target location. In this case, the pipe cleaning apparatus 1 may repeatedly move back and forth to perform the cleaning operation until the by-product is entirely removed.

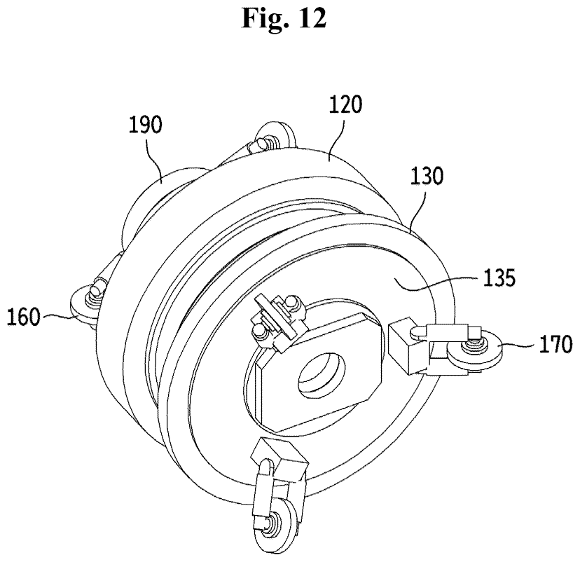

A front caster 160 may be installed on a side surface of the protrusion 190. A rear caster 170 may be installed on the plate 135. In FIG. 11 and FIG. 12, each of the number of front casters 160 and the number of rear casters 170 is illustrated as three. However, embodiments of the present disclosure is not limited thereto.

The front caster 160 and the rear caster 170 may be in contact with the pipe 600. The front caster 160 and the rear caster 170 may support the cleaning module 100. For example, when the front caster 160 and the rear caster 170 are in contact with the pipe 600 in various directions, the cleaning module 100 may be located at a center of the pipe 600. When the cleaning module 100 is not positioned at the center of the pipe 600, the front brush 120 may not contact the by-product. However, since the pipe cleaning apparatus 1 according to some embodiments of the present disclosure includes the front caster 160 and the rear caster 170, the centering of the cleaning module 100 within the pipe may be maintained.

The spray unit 180 may be installed around the camera 150. The spray unit 180 may be connected to or installed on the frame 195. The spray unit 180 may face in a frontward direction of the camera 150. Alternatively, the spray unit 180 may face the camera 150. The spray unit 180 may continuously spray air to the camera 150. When the front brush 120 rotates such that the by-product is scattered, the by-product may accumulate on the camera 150. When the by-product accumulates on the camera 150, the inside of the pipe 600 may not be observed. However, the spray unit 180 may inject the air onto the camera 150 to prevent the by-product from accumulating on the camera 150.

In some embodiments, the spray unit 180 may be connected to the pneumatic cylinder 340 (see FIG. 4). The spray unit 180 may be connected to the pneumatic cylinder 340 via a pneumatic tube 345. The pneumatic tube 345 may be branched at a branch point S. The pneumatic tube 345 may be branched into two portions respectively connected to the pneumatic cylinder 340 and the spray unit 180.

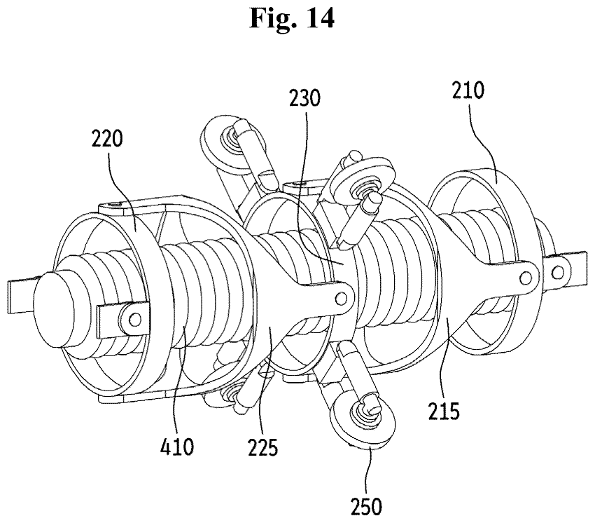

FIGS. 14 to 17 are diagrams illustrating the joint module of FIG. 4. As described above, the joint module 200 may include the first universal joint 210, the second universal joint 220, the third universal joint 230, the first link 215, the second link 225, and the second caster 250.

The joint module 200 may be installed between the driving module 300 and the cleaning module 100. The joint module 200 may connect the driving module 300 and the cleaning module 100 to each other. The joint module 200 may have a hollow space. Therefore, the suction channel 410 may extend through the joint module 200.

The first universal joint 210, the second universal joint 220, and the third universal joint 230 may be connected in series with each other in a horizontal direction.

The first universal joint 210 may be connected to the driving module 300. For example, the first universal joint 210 may be connected to the hollow frame 310. The second universal joint 220 may be connected to the cleaning module 100. For example, the second universal joint 220 may be connected to the plate 135. The third universal joint 230 may be installed between the first universal joint 210 and the second universal joint 220.

The first link 215 may be installed between the third universal joint 230 and the first universal joint 210. The first link 215 may connect the first universal joint 210 and the third universal joint 230 to each other. The second link 225 may be installed between the third universal joint 230 and the second universal joint 220. The second link 225 may connect the second universal joint 220 and the third universal joint 230 to each other.

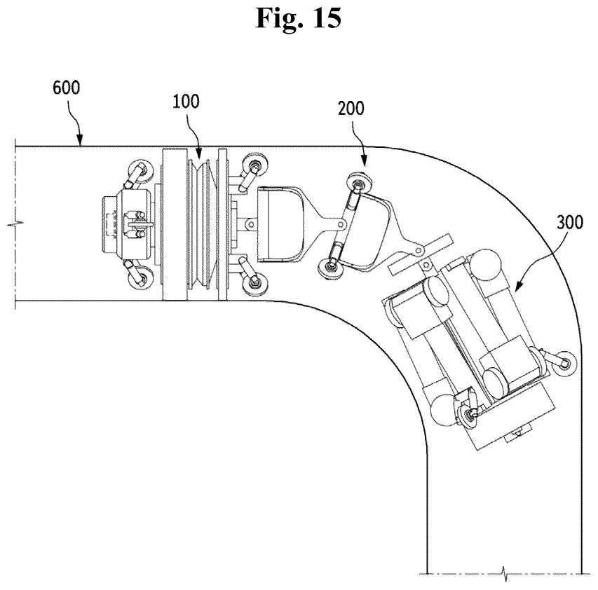

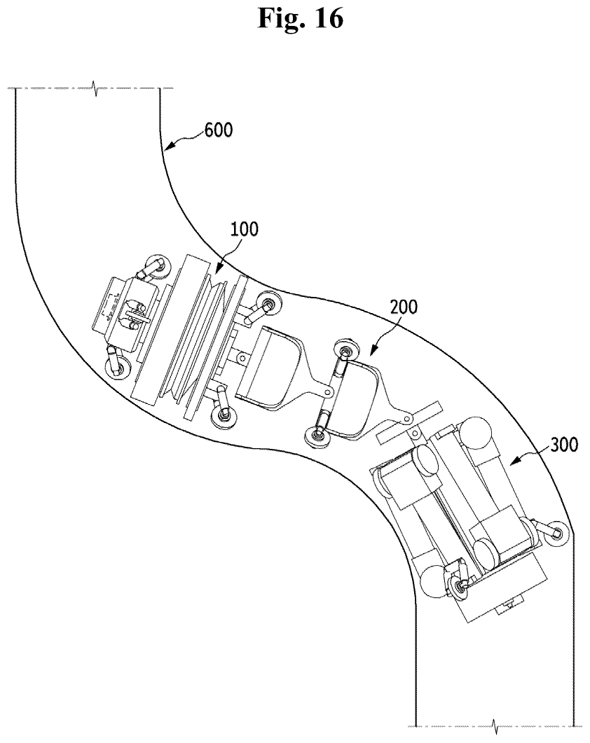

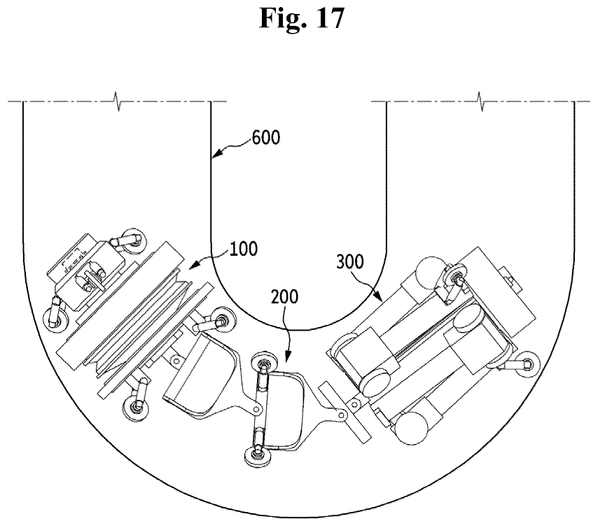

The pipe 600 used in the semiconductor process may have various shapes. For example, the pipe 600 may have a bent shape as shown in FIG. 15, an S shape as shown in FIG. 16, or a U shape as shown in FIG. 17. However, embodiments of the present disclosure are not limited thereto. The pipe cleaning apparatus 1 including the first universal joint 210, the second universal joint 220, and the third universal joint 230 may move along and in the pipe 600, which may be a bent pipe, an S-shaped pipe, or a U-shaped pipe.

The second caster 250 may be installed on the third universal joint 230. According to embodiments, the second caster 250 may be installed on the first universal joint 210 and/or the second universal joint 220.

The second caster 250 may be in contact with the pipe 600. The second caster 250 may be in contact with the pipe 600 to increase the pipe support force of the joint module 200. The second caster 250 may be in contact with the pipe 600 to allow the joint module 200 to be positioned at the center of the pipe 600.

Although non-limiting example embodiments of the present disclosure have been described above with reference to the accompanying drawings, embodiments of the present disclosure are not limited to the example embodiments and may be implemented in various different forms. Those of ordinary skill in the technical field to which the present disclosure belongs will be able to appreciate that embodiments of the present disclosure may be implemented in other specific forms without departing from the spirit and scope of the present disclosure. Therefore, it should be understood that the embodiments as described above are not restrictive but illustrative in all respects.

What is claimed is:

1. A pipe cleaning apparatus comprising:
a driving module;
a cleaning module comprising a camera and a front brush; and
a joint module connecting the driving module and the cleaning module, the joint module comprising at least one joint,
wherein the driving module comprises:
a hollow frame extending in a horizontal direction;
a pneumatic cylinder connected to a first end of the hollow frame;
a first slider installed on the hollow frame;
a second slider on the hollow frame and spaced apart from the first slider, wherein the second slider is connected to the pneumatic cylinder;
a plurality of front wheel assemblies on the hollow frame; and
a plurality of rear wheel assemblies on the hollow frame,
wherein, in a cross-sectional view of the hollow frame, the plurality of rear wheel assemblies and the plurality of front wheel assemblies are arranged alternately with each other in a circumferential direction, and
wherein the plurality of front wheel assemblies are connected to the first slider, and the plurality of rear wheel assemblies are connected to the second slider.

2. The pipe cleaning apparatus of claim 1, wherein the pneumatic cylinder is configured to extend or retract to adjust a radial dimension of each of the plurality of front wheel assemblies and each of the plurality of rear wheel assemblies.

3. The pipe cleaning apparatus of claim 1, wherein each of the plurality of front wheel assemblies comprises a first connection structure and a second connection structure that is longer than the first connection structure,
wherein each of the plurality of rear wheel assemblies comprises a third connection structure and a fourth connection structure that is longer than the third connection structure,
wherein the first connection structure is connected to a second end of the hollow frame, and the second connection structure is connected to the first slider, and
wherein the third connection structure is connected to the second slider, and the fourth connection structure is connected to the first slider.

4. The pipe cleaning apparatus of claim 3, wherein the driving module further comprises first casters on the second connection structure and the fourth connection structure, respectively.

5. The pipe cleaning apparatus of claim 4, wherein in a case where the pneumatic cylinder retracts, a radial spacing between the first casters and the hollow frame is larger than a radial spacing between each of the plurality of front wheel assemblies and the hollow frame, and between each of the plurality of rear wheel assemblies and the hollow frame.

6. The pipe cleaning apparatus of claim 1, wherein the cleaning module further comprises:
a rear brush spaced horizontally from the front brush; and
a suction part between the front brush and the rear brush.

7. The pipe cleaning apparatus of claim 6, further comprising a suction channel extending through the hollow frame and the joint module and connected to the cleaning module,
wherein the suction channel is connected to the suction part.

8. The pipe cleaning apparatus of claim 6, wherein the cleaning module further comprises:
a plate, wherein the rear brush is on the plate; and
a rear caster on the plate.

9. The pipe cleaning apparatus of claim 6, wherein the cleaning module further comprises an air sprayer configured to spray air to the camera.

10. The pipe cleaning apparatus of claim 9, further comprising a pneumatic tube connected to the pneumatic cylinder,
wherein the pneumatic tube comprises two branching portions respectively connected to the air sprayer and the pneumatic cylinder.

11. The pipe cleaning apparatus of claim 1, wherein the at least one joint of the joint module comprises:
a first universal joint connected to the driving module;
a second universal joint connected to the cleaning module; and
a third universal joint connecting the first universal joint and the second universal joint, and
the joint module further comprises a plurality of second casters on the third universal joint.

12. A pipe cleaning apparatus comprising:
a cleaning module;
a driving module; and
a joint module connecting the cleaning module and the driving module,
wherein the cleaning module comprises:
a rotator;
a front brush on a side surface of the rotator;
a camera on a front surface of the rotator;
a rear brush spaced apart from the front brush in a horizontal direction; and
a suction part between the front brush and the rear brush,
wherein the joint module comprises a first universal joint,
wherein the driving module comprises:
a hollow frame extending in the horizontal direction;
a pneumatic cylinder that is hollow and connected to a first end of the hollow frame;
a first slider on the hollow frame;
a second slider on the hollow frame and spaced apart from the first slider, wherein the second slider is connected to the pneumatic cylinder;
a plurality of front wheel assemblies on the hollow frame, wherein each of the plurality of front wheel assemblies comprises a first connection structure and a second connection structure that is longer than the first connection structure; and
a plurality of rear wheel assemblies on the hollow frame, wherein each of the plurality of rear wheel assemblies comprises a third connection structure and a fourth connection structure,
wherein, in a cross-sectional view of the hollow frame, the plurality of rear wheel assemblies and the plurality of front wheel assemblies are arranged alternately with each other in a circumferential direction,
wherein the first connection structure is connected to a second end of the hollow frame, and the second connection structure is connected to the first slider, and
wherein the third connection structure is connected to the second slider, and the fourth connection structure is connected to the first slider.

13. The pipe cleaning apparatus of claim 12, wherein the driving module further comprises first casters on the second connection structure and the fourth connection structure, respectively.

14. The pipe cleaning apparatus of claim 13, wherein in a case where the pneumatic cylinder retracts, a radial spacing between the first casters and the hollow frame is larger than a radial spacing between each of the plurality of front wheel assemblies and the hollow frame and each of the plurality of rear wheel assemblies and the hollow frame.

15. The pipe cleaning apparatus of claim 13, wherein in a case where the pneumatic cylinder extends, a radial spacing between the first casters and the hollow frame is smaller than a radial spacing between each of the plurality of front wheel assemblies and the hollow frame and each of the plurality of rear wheel assemblies and the hollow frame.

16. The pipe cleaning apparatus of claim 12, wherein the cleaning module further comprises:
a plate, wherein the rear brush is on the plate;
a rear caster on the plate; and
a front caster on a protrusion horizontally spaced from the rotator.

17. The pipe cleaning apparatus of claim 12, wherein the first universal joint is connected to the driving module, and
wherein the joint module further comprises:
a second universal joint connected to the cleaning module;
a third universal joint connected to and between the first universal joint and the second universal joint; and
a plurality of second casters on the third universal joint.

18. The pipe cleaning apparatus of claim 12, wherein the cleaning module further comprises an air sprayer configured to spray air to the camera.

19. A pipe cleaning apparatus comprising:
a cleaning module;
a driving module; and
a joint module connecting the cleaning module and the driving module,
wherein the cleaning module comprises:
a rotator;
a front brush on a side surface of the rotator;
a rear brush horizontally spaced from the front brush;
a suction part between the front brush and the rear brush;
a camera on a protrusion horizontally spaced from the rotator; and
a front caster on a side surface of the protrusion,
wherein the joint module comprises:
a first universal joint connected to the driving module;
a second universal joint connected to the cleaning module; and
a third universal joint connecting the first universal joint and the second universal joint,
wherein the driving module comprises:
a hollow frame extending in a horizontal direction;
a pneumatic cylinder that is hollow and on a first end of the hollow frame;
a first slider on the hollow frame;
a second slider on the hollow frame and spaced apart from the first slider, wherein the second slider is connected to the pneumatic cylinder;
a plurality of front wheel assemblies on the hollow frame, wherein each of the plurality of front wheel assemblies comprises a first connection structure and a second connection structure;
a plurality of rear wheel assemblies on the hollow frame, wherein each of the plurality of rear wheel assemblies comprises a third connection structure and a fourth connection structure, wherein, in a cross-sectional view of the hollow frame, the plurality of rear wheel assemblies and the plurality of front wheel assemblies are arranged alternately with each other in a circumferential direction; and
a first caster on each of the second connection structure and the fourth connection structure,
wherein the first connection structure is connected to a second end of the hollow frame, and the second connection structure is connected to the first slider, and
wherein the third connection structure is connected to the second slider, and the fourth connection structure is connected to the first slider.

20. The pipe cleaning apparatus of claim 19, wherein the cleaning module further comprises:
a plate, wherein the rear brush is on the plate;
a rear caster on the plate; and
an air sprayer configured to spray air to the camera.
